(19) United States
(12) Patent Application Publication
(10) Pub. No.: US 2011/0302757 A1
(43) Pub. Date: Dec. 15, 2011

(54) METHOD AND DEVICE FOR STRIPPING FIBRES IN A FIBRE BUNDLE

(75) Inventors: Marcin Michal Kozak, Rothenstein/Oelknitz (DE); Holger Kühn, Jena (DE); Inka Manek-Hönninger, Cestas (FR)

(73) Assignee: JT OPTICAL ENGINE GMBH + CO. KG, Jena (DE)

(21) Appl. No.: 13/139,245

(22) PCT Filed: Dec. 10, 2009
(86) PCT No.: PCT/DE2009/001732

§ 371 Date: Sep. 1, 2011

(30) Foreign Application Priority Data
Dec. 11, 2008 (DE) 102008061733.4

(51) Int. Cl. B23P 19/00

(52) U.S. Cl. 29/426.1; 29/700

(57) ABSTRACT

The invention relates to a method and a device for removing the sheath or for stripping fibres of a fibre bundle. Each fibre comprises a core and a sheath, wherein the fibres are arranged adjacent to each other on a base such as to run in a first direction, a cut is made with two blades running perpendicular to the first direction in a plane from opposing sides such that the blades from a notch in each sheath running in the circumferential direction, the fibre bundle is then dipped in a chemical solvent up to the cuts in the fibres for a given period in order to pre-weaken the connection between the sheath and the core and the pre-weakened sheath sections are mechanically drawn from the fibre cores.

The present invention relates to a method and an apparatus for stripping fibres of a fibre bundle, as are known from WO 02/093219.

Chemical, mechanical and mechanical-chemical methods are known for stripping individual fibres of a fibre bundle. However, all of these known methods are elaborate, and some are hazardous because of the chemicals used. Furthermore, defined stripping as far as a predefined edge is difficult and, in the case of the mechanical methods, very high, unwanted mechanical loads are often present. Moreover, frequently the known methods are not suitable for fibre bundles, such that each fibre of a fibre bundle must be stripped individually.

Proceeding therefrom, it is the object of the invention to provide a method for stripping fibres of a fibre bundle, by means of which stripping as far as a predefined location on the fibres of the fibre bundle can be effected easily and rapidly with little mechanical loading of the fibres. Further, a corresponding apparatus for stripping fibres of a fibre bundle is to be provided.

The object is achieved, according to the invention, by a method for stripping fibres of a fibre bundle, wherein each fibre has a core and a sheath, in which

a) the fibres are disposed next to each other on a base, such that they extend along a first direction,
b) two shaped cutters extending transverse to the first direction and disposed in one plane are used to cut into the sheaths from opposite sides, such that the cutters produce a shaped cut running in the circumferential direction in each sheath,
c) the fibre bundle is then immersed, as far as the starting cuts in the fibres, in a chemical solvent for a predefined period of time, in order to pre-weaken the bond between the sheath and the core, and
d) the pre-weakened sheath portions are mechanically drawn off the fibre cores.

By means of this method, it is possible for all fibres of the fibre bundle to be stripped simultaneously, such that the stripping can be performed rapidly. Further, because of the shaped cuts, a defined tear-off edge is produced, such that the stripped regions of the fibres all commence at the same level in the fibre bundle. Owing to the pre-weakening by means of the chemical solvent, the mechanical loads during the drawing off of the pre-weakened sheath portions are extremely small, such that damage to the exposed fibre cores can be prevented.

Here, the sheath of the fibre denotes, in particular, the part of the fibre that is removed from the fibre. Here, the core of the fibre is, in particular, the remaining part of the fibre. In the case of a single-core fibre, the commonly used terminology is applicable, such that the core of the single-core fibre is the fibre core in the meaning of the invention, and the sheath of the single-core fibre is the fibre sheath in the meaning of the invention. In the case of, for example, a double-core fibre, the core and the so-called cladding constitute the core in the meaning of the invention, and the sheath of the double-core fibre is the sheath in the meaning of the invention. Clearly, it can also be the case that the cladding is also to be removed. In this case, the cladding and sheath of the double-core fibre constitute the sheath in the meaning of the invention, and the core of the double-core fibre is the core in the meaning of the invention. The same applies to fibres having, for example, a triple or quadruple core, or to other fibres having at least one core and one sheath.

The method according to the invention makes it possible to process various fibre types such as, for example, single-core fibres, double-core fibres or other fibres having a plurality of cores, as well as differently shaped double-core fibres such as, for example, rectangular fibres, octagonal fibres or double-D fibres.

In the case of a large number of fibres to be stripped, division into technologically appropriate bundles is advantageous.

Ketones, dichloromethane or another halogenated solvent can be used as a solvent. Such halogenated solvents are particularly suitable, in particular, in the case of fibres having an acrylate sheath. The fibre core can be a glass fibre core.

In the case of the method according to the invention, in step b) the shaped cutters are used, advantageously, such that the cut depths to be produced are approximately equal in all fibre sheaths. This can be achieved, in particular, in that the cutting process is effected parallel to the base.

According to step b), the shaped cutters are disposed in such a way that the fibres are located between the two cutters. As a result, the fibres are cut simultaneously from above and below. In a particularly preferred manner, there are used for this purpose such shaped cutters that, in their geometry, are adapted to the specific geometry of the fibres, such that a cut around the entire circumference of the fibres is possible.

Preferably used for this purpose are shaped cutters made of non-corroding or low-corrosion materials such as, for example, of stainless steel, ceramic, diamond or particularly hard plastic.

Further, the shaped cutters, in particular in the case of cutters made of metallic materials, can be heated before or during step b), in order to achieve an optimal starting cut, wherein the temperature is advantageously adapted to the type and thickness of the fibre sheath. Typically, such a temperature is in the range of up to 120° C.

Furthermore, in step b), vibrations, in particular high-frequency vibrations such as, for example, ultrasonic vibrations, can be applied to the shaped cutters, in order thus to enable a more effective starting cutting, or cutting, at the sides of the fibres, since this causes scoring of the side edges of the fibre sheaths that cannot be fully encompassed by the shaped cutters.

Further provided is an apparatus for stripping fibres of a fibre bundle, wherein each fibre has a core and a sheath, wherein the apparatus comprises a cutting module that has a base, a holding unit and a cutting unit, and a pre-weakening module that has an immersion unit and a container having a chemical solvent, wherein the holding unit holds the fibre bundle on the base in such a way that the fibres are disposed next to each other and extend along a first direction, the cutting unit has two shaped cutters that extend transverse to the first direction and that cut into the sheaths of the fibres such that the cutters produce a shaped cut running in the circumferential direction in each sheath, and wherein the immersion unit immerses the fibre bundle, as far as the cuts in the fibres, in the solvent in the container for a predefined period of time, in order to pre-weaken the bond between the sheath and the core.

In the case of the apparatus according to the invention, the shaped cutters are disposed, advantageously, such that the cut depths to be produced are approximately equal in all fibre sheaths. This can be achieved, in particular, in that the cutters are disposed parallel to the base.

According to the apparatus according to the invention, the shaped cutters are disposed in such a way that the fibres are located between the two cutters. As a result, the fibres are cut into simultaneously from above and below.

Preferably, the shaped cutters are produced from a non-corroding or low-corrosion material such as, for example, from stainless steel, ceramic, diamond or particularly hard plastic.

Further, the apparatus according to the invention can have a source for heating the shaped cutters, such that, in particular, metallic cutters can be heated in order to achieve an optimal shaped cut, wherein the temperature is advantageously adapted to the type and thickness of the fibre sheath.

Furthermore, the apparatus can have a vibration source, in particular a high-frequency vibration source such as, for example, an ultrasound source, which can be applied to the shaped cutters, in order thus to enable a more effective cutting at the sides of the fibres. This can cause scoring of the side edges of the fibre sheaths that cannot be directly contacted by the shaped cutters.

By means of the apparatus, the desired stripping can be performed easily, since it is then necessary only for the pre-weakened sheath portions to be mechanically drawn off, which is possible because of the pre-weakening. Owing to the shaped cuts, it is also only the pre-weakened sheath portions that are actually drawn off, such that defined stripping is effected.

The apparatus can have a holding plate, on which the fibre bundle is fixed, wherein the holding plate is insertable both into the cutting module and into the pre-weakening module, and the cutting module and the pre-weakening module, with the holding plate inserted, are able to perform, respectively, the intended shaped cutting and the intended pre-weakening without the fibre bundle having to be re-fixed on the holding plate. The operation of the apparatus is thereby facilitated.

According to the invention, the shaped cutters are disposed in such a way that the fibres are located between the two cutters. As a result, the fibres are cut into simultaneously from above and below. In particular, the shaped cutters of the cutting unit can extend parallel to the base. As a result, the cut depth of the shaped cutters is the same in all sheaths of the fibres.

In a particular embodiment, the apparatus according to the invention is equipped with at least one settable spacer, for regulating the distance of the shaped cutters. This enables the apparatus to be adapted to differing fibre types and fibre thicknesses, through selection of appropriately shaped cutters and regulation of the distance thereof.

It is understood that the features mentioned above and those yet to be explained in the following are applicable, not only in the stated combinations, but also in other combinations or singly, without departure from the scope of the present invention.

The invention is explained by way of example in yet greater detail in the following with reference to the attached drawings, which also disclose features essential to the invention. There are shown in:

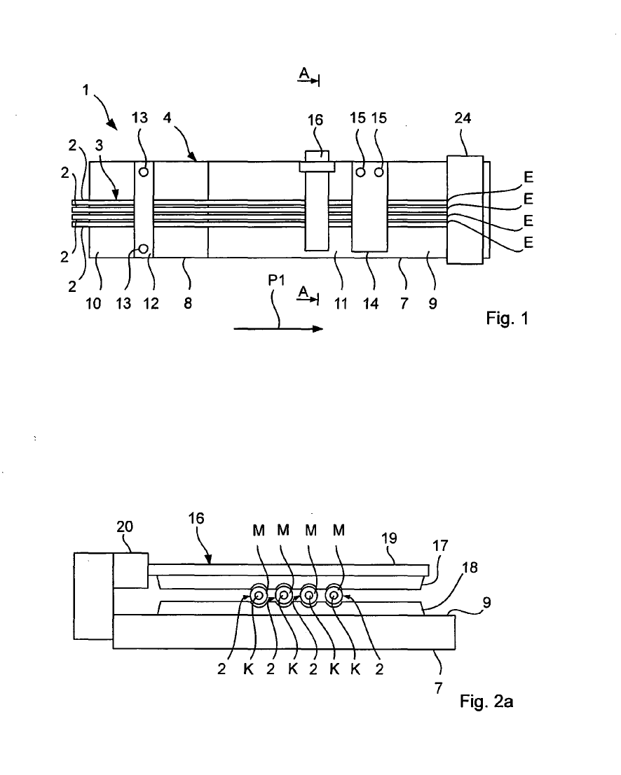

FIG. 1 a schematic view of a cutting module of a first embodiment of the apparatus, according to the invention, for stripping fibres of a fibre bundle;

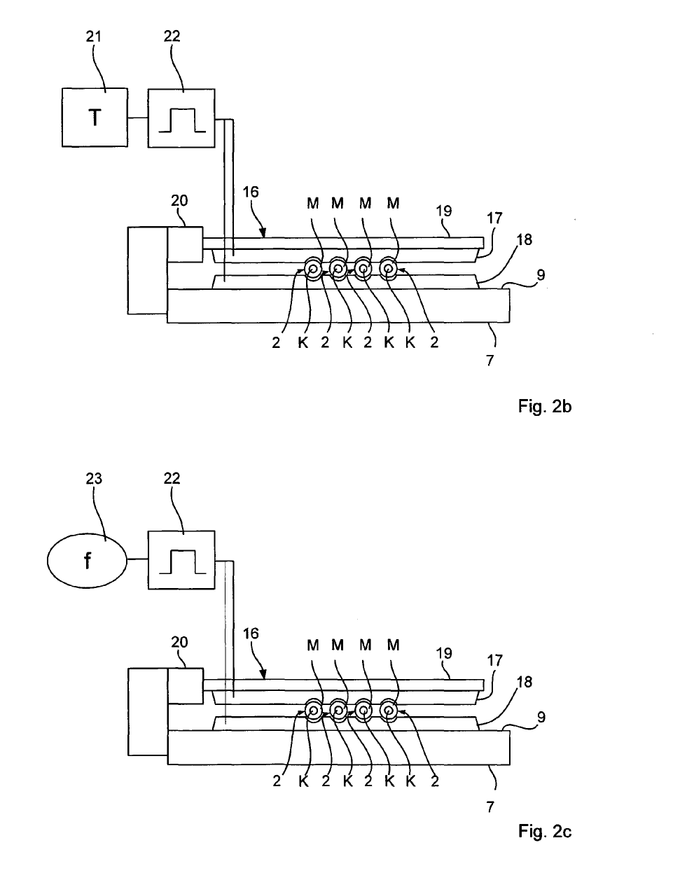

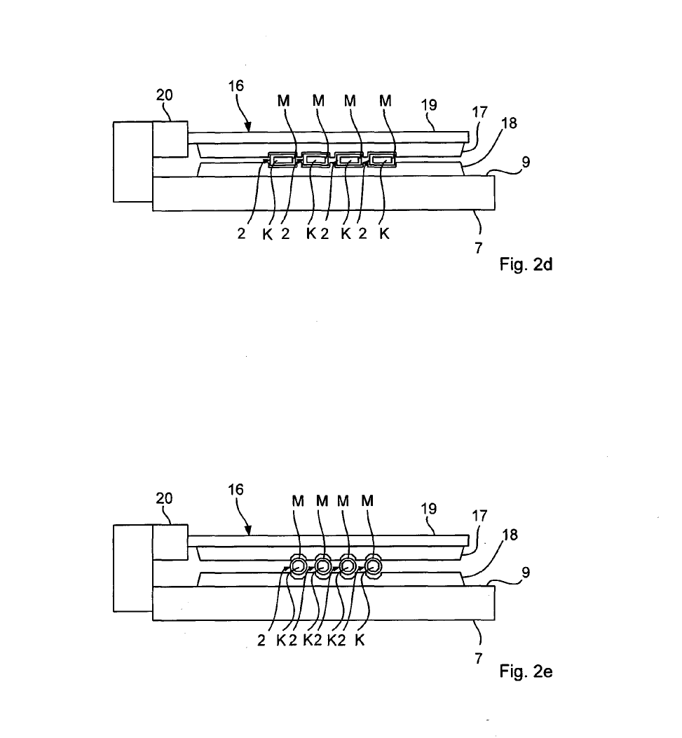

FIG. 2a an enlarged sectional view along the section line A-A of FIG. 1, as a preferred embodiment;

FIG. 2b an enlarged sectional view along the section line A-A of FIG. 1, as an embodiment having an additional heating source;

FIG. 2c an enlarged sectional view along the section line A-A of FIG. 1, as an embodiment having an additional ultrasound source;

FIG. 2d an enlarged sectional view along the section line A-A of FIG. 1, as an embodiment having shaped cutters for rectangular fibres;

FIG. 2e an enlarged sectional view along the section line A-A of FIG. 1, as an embodiment having shaped cutters for octagonal fibres;

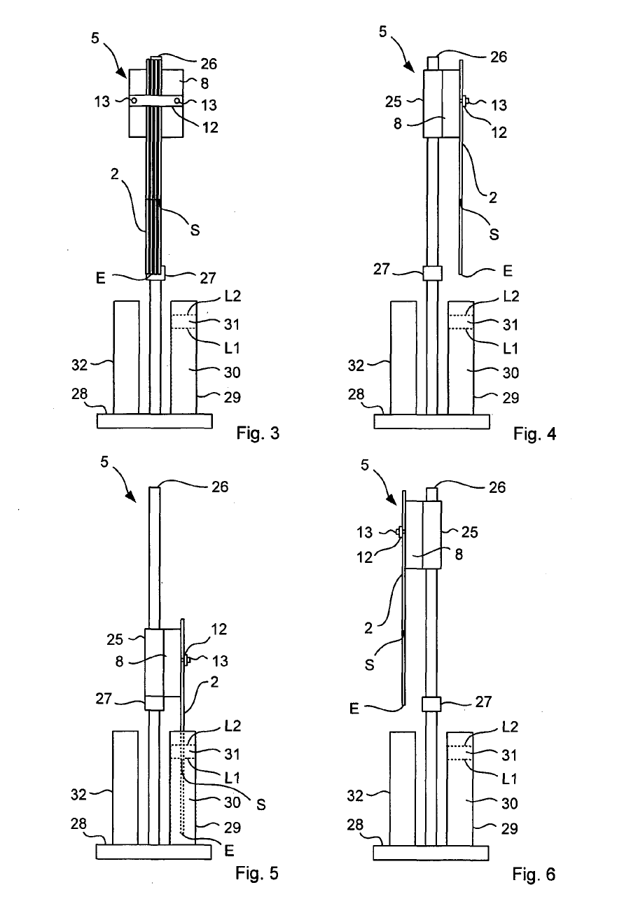

FIG. 3 a schematic view of a pre-weakening module of the first embodiment of the apparatus, according to the invention, for stripping fibres of a fibre bundle;

FIG. 4 a different position of the holding plate in the case of the pre-weakening module according to FIG. 3;

FIG. 5 a further position of the holding plate in the case of the pre-weakening module according to FIG. 3;

FIG. 6 yet a further position of the holding plate in the case of the pre-weakening module of FIG. 3;

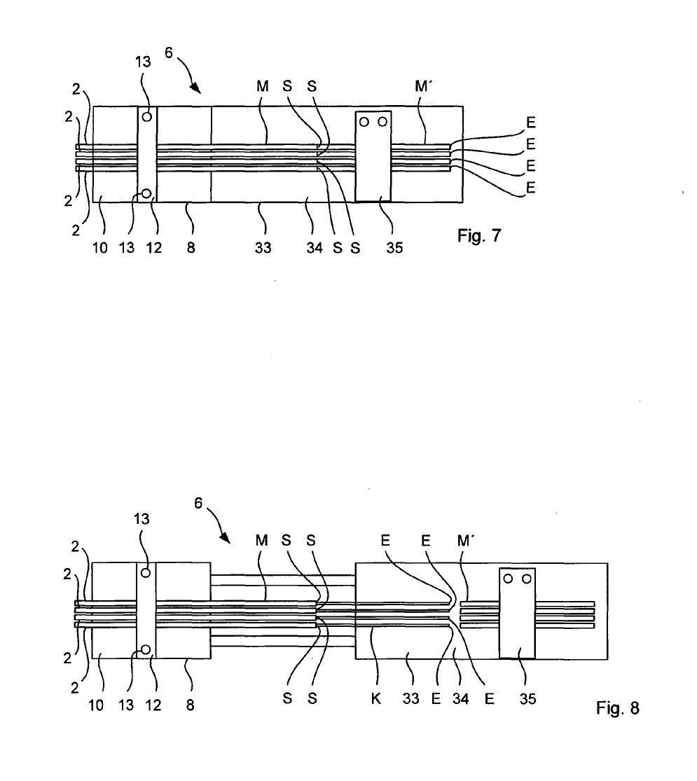

FIG. 7 a schematic view of a draw-off module of the first embodiment of the apparatus, according to the invention, for stripping fibres of a fibre bundle;

FIG. 8 the draw-off module in a position differing from that in FIG. 7;

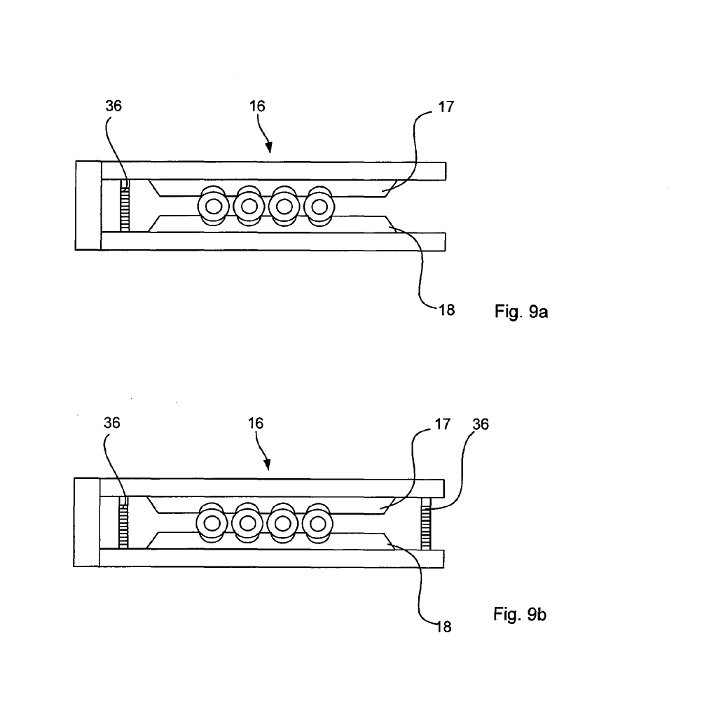

FIG. 9a a sectional view of an embodiment of a cutting module having a regulatable spacer;

FIG. 9b a sectional view of an embodiment of a cutting module having two regulatable spacers.

In the case of the embodiments shown in FIGS. 1-8, the apparatus 1, according to the invention, for stripping fibres 2 of a fibre bundle 3 comprises a cutting module 4 (FIGS. 1 and 2), a pre-weakening module 5 (FIGS. 3-6), and a draw-off module 6 (FIGS. 7 and 8).

The cutting module 4 comprises a carrier plate 7 and a holding plate 8, which is connected to the carrier plate 7 and whose top sides 9, 10 constitute a continuous, flat bearing surface 11.

On the bearing surface 11, the fibre bundle 3 lies such that the individual fibres 2 lie next to each other and extend substantially parallel to each other along a first direction, which is indicated by the arrow P1. By means of a first clamping web 12, which is fastened on the holding plate 8 by screws, the fibres 2 are pressed against the top side 10 of the holding plate 8 and are thereby held. At a distance from the first clamping web 12 along the direction P1, a second clamping web 14 is fastened on the carrier plate 7 by screws 15, such that the fibres 2 are pressed against the top side 9 of the carrier plate 7 and are thereby clamped in between the second clamping web 14 and the carrier plate 7. Disposed between the two clamping webs 12 and 14 there is a cutting unit 16. As can best be seen from the sectional representation of FIG. 2a, the cutting unit 16 has two shaped cutters 17 and 18, which extend transverse to the direction P1 and which are fastened to a cutter carrier 19, or to the top side 9 of the carrier plate 7. The cutter carrier 19 is fastened to an adjusting slide 20, represented schematically, via which the distance of the cutter carrier 19, and thus of the shaped cutter 17, from the opposite shaped cutter 18 can be set. In the case of the position of the adjusting slide 20 shown in FIG. 2a, in the case of each of the four fibres 2 the cutters 17 and 18 cut into the sheath M of the fibre 2, but not as far as the fibre core K.

FIG. 2b shows an embodiment having an additional heating source 21 for heating the shaped cutters 17 and 18, which are connected to the heating source 21 through an appropriate control unit 22.

FIG. 2c shows an embodiment having an additional ultrasound source 23, which applies ultrasound to the shaped cutters 17 and 18 via an appropriate control unit 22.

It is understood that the embodiments according to FIGS. 2b and 2c can also be applied with a plurality of heating sources or a plurality of vibration sources, in particular high-frequency vibration sources, or can also be applied with these embodiments being combined.

FIG. 2d shows an embodiment having shaped cutters 17 and 18 that are suitable for cutting rectangular fibres.

FIG. 2e shows an embodiment having shaped cutters 17 and 18 that are suitable for cutting octagonal fibres.

It is understood that the shaped cutters 17 and 18 can also be adapted in their shape to fibres 2 having another shape such as, for example, double-D fibres, oval fibres or fibres of another geometry.

As further shown in FIG. 1, the carrier plate 7 has a fibre stop 24, on which the front ends E of the fibres 2 bear. As a result, all shaped cuts S in the fibres 2 of the fibre bundle 3 are at the same level (or the distance from the front end E of the fibres 2 to the shaped cut S is of equal size for all fibres 2 of the bundle 3). The fibre stop can be displaced along the direction P1. The distance of the shaped cuts S from the front ends E can thereby be defined.

After the shaped cuts S have been made, the shaped cutters 17 and 18 are moved upwards relative to the top side 9 of the carrier plate 7 by means of the adjusting slide 20, such that the shaped cutters 17 and 18 no longer cut into the sheath M of the fibres 2, and the screws 15 of the second clamping web 14 are undone, such that the fibre bundle 3 can be removed, together with the holding plate 8, from the cutting module 4.

The holding plate 8, together with the fibre bundle 3, is then fastened to an adapter 25 of the pre-weakening module 5, as shown schematically in FIG. 4. The adapter 25 sits on a rod 26 of the pre-weakening module 5 and, on the one hand, can be rotated about the longitudinal axis of the rod 26 (FIGS. 3, 4 and 6) and, on the other hand, can be displaced along the longitudinal direction of the rod 26 (FIG. 5).

The rod 26 has a stop 27, and is fastened on a base plate 28 that carries a container 29, for receiving a solvent 30, and an ultrasound bath 32.

The container 29 is filled with a solvent 30, wherein dichloromethane (DCM) is used here as the solvent. The fill level of the solvent 30 is indicated by the broken line L1. As indicated by the broken line L2, a water layer 31 is provided on the dichloromethane 30. The water layer serves, on the one hand, as a vapour block, in order that the solvent 30 does not evaporate, and, on the other hand, as a creep stop, as described in yet greater detail in the following.

The vapour block serves, in particular, to protect the user of the pre-weakening module from hazardous vapours of the solvent.

The holding plate 8 is now rotated, starting from the position of FIG. 3, about the rod 26 (FIG. 4) and displaced along the longitudinal direction of the rod 26 to such an extent that the adapter 25 bears on the stop 27, as shown in FIG. 5. The position of the stop 27 in this case is selected such that the fibres 2 are immersed in the solvent 30 as far as their shaped cuts S. The shaped cuts are thus located exactly at the boundary surface between the solvent 30 and the water layer 31 (line L1). The solvent 30 causes the bond between the acrylate sheath M and the glass core K to be dissolved in the region from the front end E of the fibres 2 as far as the shaped cut S. It is not possible for the solvent 30 to creep up over the shaped cut S, because of the water layer 31, which thus serves as a creep stop.

After a predefined period of time of action of the solvent 30, the adapter 25, with the holding plate 8, is pushed upwards, such that the fibres are drawn out of the container 29. The adapter 25, with the holding plate 8, can then be rotated about the rod (as indicated in FIG. 6), and then immersed in the ultrasound bath 32 for cleaning (not shown).

The thus pre-weakened and cleaned fibres 2 are separated, together with the holding plate 8, from the adapter 25 and inserted in the draw-off module 6 (FIG. 7). The draw-off module 6 has a substrate plate 33, to which the holding plate 8 is connected such that the top side 34 of the substrate plate 33 is in alignment with the top side 10 of the holding plate 8. A clamping element 35 is then applied over the pre-weakened portions of the fibres 2, and is connected to the substrate plate 33, such that the pre-weakened portions are clamped onto the substrate plate 33.

The substrate plate 33 (seen in FIGS. 7 and 8) is then moved to the right, such that the pre-weakened sheath portions M′ of the fibres 2 are drawn off to the right and the fibre cores K are exposed. Owing to the shaped cuts S and the selective weakening from the front ends E to only as far as the shaped cuts S, a sheath end edge of the fibres 2 is obtained that, on the one hand, is in alignment. On the other hand, the sheath edge is very sharp and precisely defined.

Clearly, it is also possible for a person, after releasing the holding plate 8 from the adapter 25, to draw off the pre-weakened sheath portions M′ by hand, such that it is possible to dispense with the draw-off module 6 in this case.

In the case of the embodiments described hitherto, the front ends E of the fibres 2 were all at the same level. This can be, but need not be, the case. It is quite possible for the fibre ends of the fibres 2 not to be at the same level. For this purpose, it is possible, for example, to dispense with the fibre stop 24 in the case of the cutting module 4.

In particular embodiments (FIGS. 9a and b), the apparatus according to the invention is equipped with a cutting unit (16) that includes one or two settable spacers (36) for regulating the distance of the shaped cutters (17, 18). This enables the cutting unit (16) to be set very precisely to a fibre diameter, such that, in the cutting operation, it is ensured that cuts are made as deeply as possible into the respective sheaths M, but are not made into the fibre cores K.

Further, a design with spacers (36) enables the cutting unit (16) to be used for various fibre types and/or fibre thicknesses, wherein the cutters (17, 18) are merely exchanged and the distance adapted.

1. A Method for stripping fibres of a fibre bundle, wherein each fibre has a core and a sheath, comprising:
a) disposing the fibres next to each other on a base, such that they extend along a first direction,
b) providing two shaped cutters extending transverse to the first direction and disposed in one plane to cut into the sheaths from opposite sides, such that the cutters produce a shaped cut running in the circumferential direction in each sheath,
c) immersing the fibre bundle, as far as the shaped cuts in the fibres, in a chemical solvent for a predefined period of time, in order to pre-weaken the bond between the sheath and the core, and
d) drawing mechanically the pre-weakened sheath portions off the fibre cores.

2. The Method according to claim 1 wherein the shaped cutters in step b) extend parallel to the base.

3. The Method according to claim 1, wherein the shaped cutters are composed of non-corroding or low-corrosion materials.

4. The Method according to claim 1, wherein the shaped cutters are heated before or during step b).

5. The Method according to claim 1, wherein vibrations, in particular high-frequency vibrations, are applied to the shaped cutters in step b).

6. The Method according to claim 5, wherein the vibrations are ultrasonic vibrations.

7. The Method according to claim 1, wherein the shaped cutters are heated before or during step b) and high-frequency vibrations are applied to the shaped cutters.

8. An Apparatus for stripping fibres of a fibre bundle, wherein each fibre has a core (K) and a sheath (M), comprising:
a cutting module comprising a base, a holding unit and a cutting unit; and
a pre-weakening module comprising an immersion unit and a container including a chemical solvent,
wherein the holding unit holds the fibre bundle on the base in such a way that the fibres are disposed next to each other and extend along a first direction, the cutting unit including at least two shaped cutters that extend transverse to the first direction and that cut into the sheaths of the fibres such that the shaped cutters produce a shaped cut running in the circumferential direction in each sheath,
and wherein the immersion unit immerses the fibre bundle, as far as the shaped cuts in the fibres, in the solvent in the container for a predefined period of time, in order to pre-weaken the bond between the sheaths and the cores.

9. The Apparatus according to claim 8, wherein the fibre bundle is fastened on a holding plate that is insertable into the cutting module and into the pre-weakening module, wherein, in the inserted state, no alteration of the fastening of the fibre bundle on the holding plate is necessary for use of the cutting module and of the pre-weakening module.

10. The Apparatus according claim 8, wherein the shaped cutters of the cutting unit extend parallel to the base.

11. The Apparatus according to claim 8, wherein the shaped cutters comprise non-corroding or low-corrosion materials.

12. The Apparatus according to claim 8, wherein the cutting unit comprises at least one additional heating source for heating the shaped cutters.

13. The Apparatus according to claim 8, wherein the cutting unit comprises at least one additional vibration source.

14. The Apparatus according to claim 13, wherein the vibration source is an ultrasound source.

15. The Apparatus according to claim 8, wherein the cutting unit comprises at least one heating source and at least one vibration source.

16. The Apparatus according to claim 8, wherein the cutting unit includes at least one settable spacer for regulating the distance of the shaped cutters.

17. The Apparatus according to claim 8, wherein the shaped cutters are adapted, in their geometry, to the specific geometry of the fibres.

18. The Apparatus according to claim 17, wherein the shaped cutters are adapted, in their geometry, to round fibres.

19. The Apparatus according to claim 17, wherein the shaped cutters are adapted, in their geometry, to rectangular fibres.

20. The Apparatus according to claim 17, wherein the shaped cutters are adapted, in their geometry, to octagonal fibres.
